(19) United States
(12) Patent Application Publication
(10) Pub. No.: US 2003/0037165 A1
(43) Pub. Date: Feb. 20, 2003

(54) Dynamic load sharing system using a virtual router

(76) Inventor: Daisuke Shinomiya, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/058,839

(22) Filed: Jan. 28, 2002

(30) Foreign Application Priority Data
Jul. 6, 2001 (JP) 2001-206856

(51) Int. Cl. G06F 15/173; G06F 9/00

(52) U.S. Cl. 709/238; 709/105

(57) ABSTRACT

To provide a load sharing system using a virtual router facilitating dynamic load distribution. The load sharing system includes a plurality of equipment units each functioning as a router which constitutes a virtual router having a single common address; and end systems being connected to the network through the virtual router. Among the plurality of routers constituting the virtual router, one equipment unit functioning as a router is assigned as a master router, while the other equipment unit(s) is assigned as a backup router. The master router dynamically allocates packet condition for defining the routing object to each router, then to advertise to the backup router. Routing processing between the network and the end system is performed by the plurality of routers each having a routing function.

### FIELD OF THE INVENTION

The present invention relates to a dynamic load sharing system for data communication using a network repeater (router), particularly a virtual router.

### BACKGROUND OF THE INVENTION

In recent years, with a rapid increase of personal computers, corporate IP networks (intranets) are becoming widely used in various companies. At the same time, computers and networks have been improved in view of both functionality and performance.

The intranets are used not only for the electronic mail and the WWW (World Wide Web) but also for multimedia data communication such as streaming. Use of the IP (Internet Protocol) as communication protocol for these purposes shares large proportion and this tendency is still in progress.

In addition, networks become to handle wider variety of data, for example, moving images, files of business applications, etc. Data allowing limited delay are now being transmitted in an identical network.

In general, a network is connected to other networks through a router or a layer three switch. In other words, a router is used for connecting one network to other networks.

When a router fails in such circumstances communication to servers in other network is impeded, which may cause a serious problem of interrupting business jobs. One solution to this problem is to provide a plurality of routers in a single site. However, it is not possible to cope with a fault because a default (initial set) gateway must be assigned statically in an end user system where a personal computer or the like having no dynamic route switchover function is employed.

In order to cope with the above-mentioned problem, a method was proposed that a virtual router constituted by a plurality of routers is provided to switch over a router when a fault occurs. Fault tolerance is improved by introducing this method. Practically, there has been developed a technique called VRRP (Virtual Router Redundant Protocol) standardized by the IETF (Internet Engineering Task Force; an international organization on the Internet technology), or a method called hot standby.

Here, the above VRRP is a protocol for dynamically selecting one router as a default router (default gateway) from a virtual router constituted by a plurality of routers in a network. Virtual router is a concept in which a network as a whole is regarded as a router.

The above-mentioned virtual router is constituted by a plurality of routers the operation of which is classified into two: a master router which actually performs routing processing; and a backup router which performs routing processing in place of the master router when the master router fails. When a fault occurs in the master router, a backup router newly becomes a master router substituting for the failed master router to continue communication processing. Thus the improved reliability is realized.

The above-mentioned technique aims to improve the reliability by employing a redundant configuration. Switchover to a standby router is carried out when a fault occurs either in a working router (i.e. master router) or on a route within a relevant supervisory domain.

Here, the standby router is also in a working condition for sending and receiving a packet for determining whether or not a fault occurs in the master router. However, a routing function of the standby router is set inactive, in other words the standby router does not contribute to actual system performance.

To cope with this issue, in the VRRP standardized by IETF, or the like, static load sharing is enabled by dividing the whole routers into a plurality of groups. However, a varying load condition is not taken into account in this method. There may be a case that a large portion of load is concentrated on a certain router(s) and that desired load sharing is not attained.

### SUMMARY OF THE INVENTION

Accordingly, it is an object of the present invention to solve the aforementioned problem and to provide a dynamic load sharing system employing a virtual router to share the load dynamically.

In order to solve the above problem, according to the present invention, a plurality of routers constituting a virtual router perform routing function concurrently based on dynamically set a packet condition for defining the routing object by each router.

In addition, the packet condition for routing is periodically reviewed based on the flow rate, etc., so that the plurality of router operate under the equivalent load conditions, thus enabling efficient load sharing in the routing processing.

A virtual router is constituted by a master router which performs actual routing processing, and a backup router which substitutes for the master router on occurrence of a fault on the master router.

In the conventional method, a backup router simply discards whole received packets. On the other hand, according to the present invention, the backup router performs actual routing function on the packets conforming to a specified packet condition. Thus, a plurality of routers are set in operation. Other packets to which the packet condition is not specified are discarded in a similar manner to the conventional method. In this method of the present invention, load sharing is not carried out statically by dividing routers into groups. A single default gateway is set in each end system.

As a feature of a dynamic load sharing system using a virtual router, the system according to the present invention includes a plurality of equipment units each functioning as a router which constitutes said virtual router having a single common address; and an end system being connected to a network through the virtual router. One of the equipment among a plurality of equipment units each functioning as a router which constitutes the virtual router is assigned as a master router, while each of the other equipment functioning as a router is assigned as a backup router. The master router dynamically sets a packet condition for defining the routing object and notifies the backup router of the packet condition, so that a routing processing between the network and the end system is performed by the plurality of equipment units functioning as a router.

As a preferred embodiment of the present invention, when backup router receives an advertisement of packet routing condition from the master router, the backup router transmits a response message to the master router.

As another preferred embodiment of the present invention, after the master router notifies the backup router of the packet condition for defining the routing object to be routed by the backup router, the master router removes the packet condition being transmitted to backup router from a packet condition for defining the routing object to be routed by the master router itself.

Further, as still another preferred embodiment of the present invention, after the backup router transmits the response to the master router, the backup router is set so as not to perform the routing processing for a certain period.

Still further, as another preferred embodiment of the present invention, when the master router receives a response message packet from the backup router, the master router removes the packet condition for defining the routing object and notifies the backup router of the packet sequence number of which routing processing is completed by the master router.

Further scopes and features of the present invention will become more apparent by the following description of the embodiments with the accompanied drawings.

### BRIEF DESCRIPTION OF THE DRAWINGS

FIG. 1 shows a schematic diagram illustrating a VRRP function.

FIG. 2 shows a functional block diagram of a router which realizes the VRRP function.

FIG. 3 shows a message format for use in VRRP.

FIG. 4 shows a functional block diagram of a router which realizes the function of the present invention.

FIG. 5 shows an example block diagram of a detailed configuration of a virtual router controller for distributed processing in the configuration shown in FIG. 4.

FIG. 6 shows an example block diagram of a detailed configuration of a packet monitor 39 in the configuration shown in FIG. 4.

FIG. 7 shows a network configuration having another subnet.

FIGS. 8A and 8B show diagrams of ICMP message formats.

FIGS. 9A through 9C show examples of information retained in a distributed processing data table 32.

FIGS. 10A through 10F show the extended formats of an allocation packet and an allocation confirmation packet to be applied for the present invention, in contrast to the format shown in FIG. 3.

FIG. 11 shows an example of a general data table.

FIG. 12 shows a diagram indicating a packet flow between a master router, a backup router and an end system, in an initial operation including the prevention of packet duplication.

FIG. 13 shows a diagram illustrating a processing flow in the case a request is sent from a backup router 3-2.

FIG. 14 shows a system configuration in the case a substitution server is provided for substituting the processing to be performed by a master router.

FIG. 15 shows an operation flowchart in the case the substitution server substitutes the processing for the master server.

FIG. 16 shows an operation sequence diagram when the substitution server is used.

FIG. 17 shows a diagram illustrating an application of the present invention to a case in which a plurality of business firms are connected through a network providing an IP virtual dedicated line service.

### DETAILED DESCRIPTION OF THE PREFERRED EMBODIMENTS

The preferred embodiments of the present invention described hereinafter are based on the standard VRRP technique. However, it should be noted that the application of the present invention will not be restricted to the VRRP technique. The present invention is applicable to other similar techniques uniquely developed by individual venders.

For the sake of understanding of the present invention, outline of the VRRP is described prior to the description of embodiments according to the present invention.

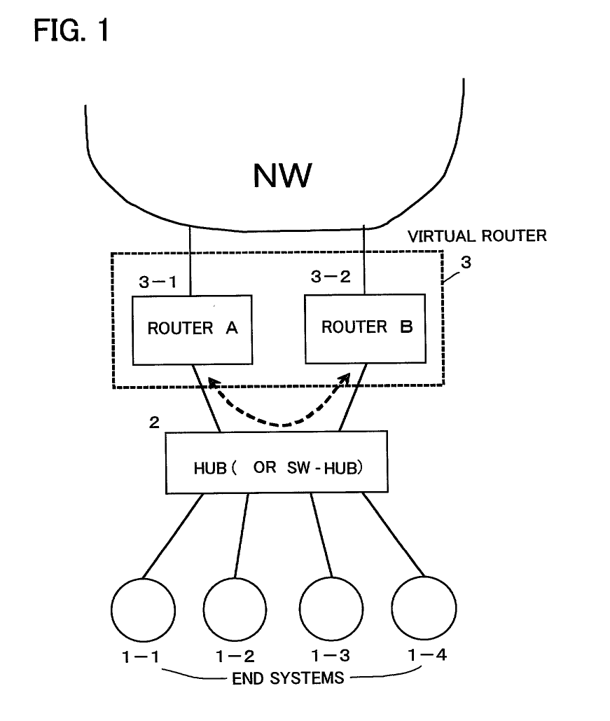

In FIG. 1, a drawing illustrating an outline of VRRP is shown. As shown in this figure, a plurality of end systems 1-1 to 1-4 such as personal computers are connected to a virtual router 3 through a hub (or switching hub) 2. The VRRP is applied to such a system. Virtual router 3 is constituted by a plurality of routers (A) 3-1 and (B) 3-2 to be coupled to other networks. Fault tolerant capability is achieved by switching a working router, for example, from router 3-1 to router 3-2 instantly in the event of a fault.

However, in a system where VRRP is not applied, communication routes can only be set statically against the plurality of end systems 1-1 to 1-4. Therefore, if either router 3-1 or 3-2 is directly designated for a default gateway, the switchover cannot be performed on occurrence of a fault even the other router than the working router can perform normal operation.

On the other hand, in a system where VRRP is introduced, a priority is assigned in each router 3-1, 3-2. Here, higher priority is assigned to the router which is given a real address identical to the IP address of virtual router 3. This router functions as a master router performing real routing processing. As an example, it is assumed that router has high priority, and therefore is assigned as a default master router.

Router 3-1 assigned as the master router transmits an advertisement packet indicating the router itself being the master router to the whole routers except router 3-1 itself which constitute virtual router 3 (i.e. to the whole backup routers). Meanwhile, router 3-2, which was not assigned as the master router, monitors an advertisement packet to confirm that the master router 3-1 is working. If an advertisement packet is not received for a predetermined period, router 3-1 substitutes for the master router. In this case, when there are a plurality of backup routers, a router having the highest priority of all routers functions as the master router. The remainder routers continue to be backup routers to monitor the master router.

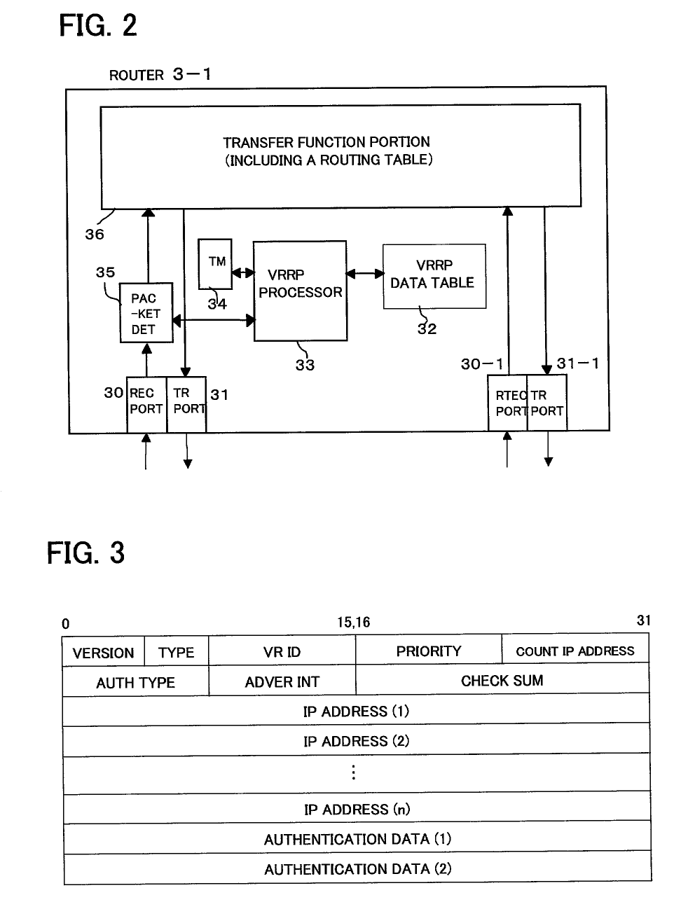

In FIG. 2, there is shown a block diagram illustrating a processing function provided in each plurality of routers constituting virtual router 3. Referring to this figure, detailed function of each plurality of routers is described taking a typical example of router 3-1.

Each function block shown in FIG. 2 is configured by either hardware or software. In this example, it is assumed that VRRP is applied to only a single pair of transmission/reception port 30, 31 out of two transmission/reception port pairs 30, 31 and 30-1, 31-1.

Each router retains the information on virtual router 3 to which the self router belongs in VRRP data table 32. Here, the retained information includes IP addresses of routers 3-1, 3-2 constituting virtual router 3, an IP address of virtual router 3, etc.

In the initial state of VRRP processor 33, the IP address of the router itself is compared with the IP address of virtual router 3 according to the information in VRRP data table 32, to confirm whether or not the own router is qualified to be a master router.

If the router is qualified as the master router, an advertisement packet is prepared based on the information in VRRP table 32, to transmit via transmission port 31 to all backup routers in virtual router 3.

In FIG. 3, a packet format is shown. Here, the information in each field is defined as follows:

Version: VRRP protocol version. Presently version=1.

Type: VRRP packet type. Presently type=1 (advertisement packet) is assigned only.

VRID: Virtual router ID, for identifying the routers in an identical virtual group.

Priority: Greater value denotes higher priority.

Count IP Address: The number of routers belonging to the virtual router.

Auth Type: Identification of authentication method.

Adver Int: Transmission time interval between advertisement packets.

Checksum: Packet error check (checksum)

IP Address: Router IP address(es) constituting a virtual router. The total number agrees with the number of routers.

In FIG. 2, VRRP processor 33 orders a timer 34 to initiate time count so as to periodically transmit an advertisement packet having the format shown in FIG. 3 from the moment a router starts to function as the master router.

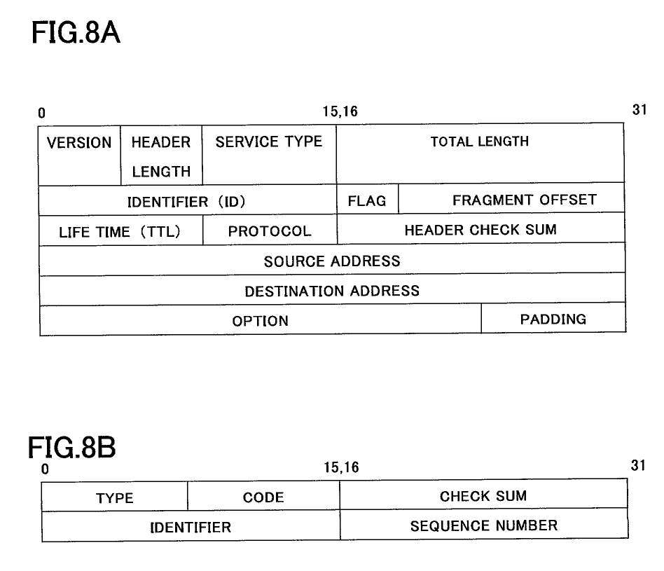

Router 3-2 now functioning as a backup router receives a packet via a reception port 30. A packet determination portion 35 in router 3-2 determines whether or not the received packet is the VRRP advertisement packet. This determination is performed using ‘Protocol’ in the IP header (refer to FIG. 8A) and ‘Type’ in the format shown in FIG. 3.

In a packet determination portion 35 of backup router 3-2, if the received packet is an ordinary packet to be routed, by determining ‘Type’ is other than 1, the packet is discarded, because the backup router does not perform routing function. On the other hand, if the received packet is a VRRP advertisement packet, the packet is transferred to a VRRP processor 33 so as to process further.

VRRP processor 33, on reception of the advertisement packet, orders timer 34 to reset the counted timer value. In the backup router, this counted timer value in timer 34 is used for measuring the transmission period of the advertisement packet from the master router. If the packet is not transmitted for a certain period, VRRP processor 33 prepares to switch from the backup router to the master router.

By means of such a router operation based on VRRP, it becomes possible to continue communication in the event of a fault by switching over a router. The embodiments of the present invention based on the aforementioned VRRP processing are now described hereinafter.

In the following description, a single virtual group is assumed. However, the present invention is also applicable to a plurality of virtual groups.

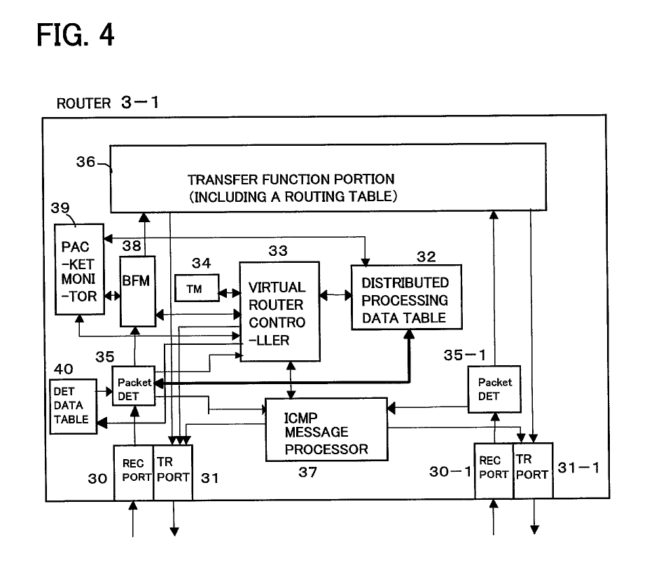

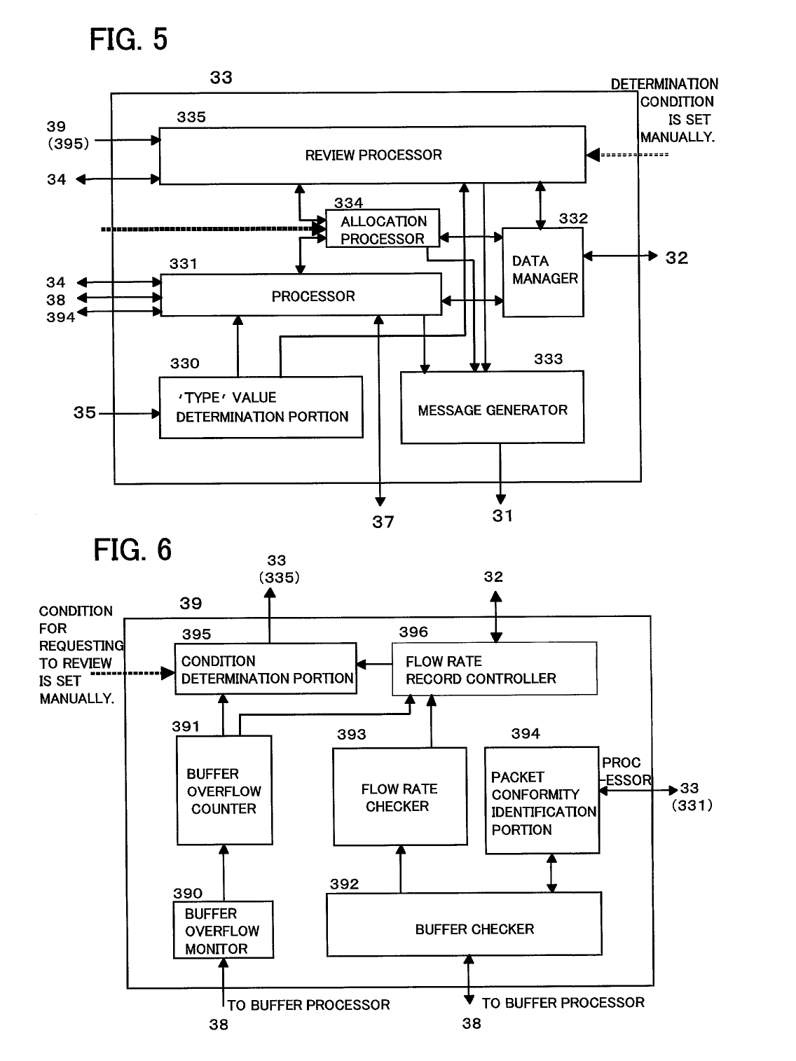

In FIG. 4, there is shown an example of the configuration block diagram according to the present invention. FIG. 5 shows a detailed configuration block diagram of a virtual router controller for distributed processing (VR-CONT) 33 shown in FIG. 4. Further, FIG. 6 shows a detailed configuration block diagram of a packet monitor (PCKT-MON) 39.

As mentioned above, the switchover of the routers is initiated when an advertisement packet is not received from the master router for a predetermined period. Switchover from any backup router to the master router is performed at that timing.

When switching over to the master router, a backup router having the highest priority of the whole backup routers is selected. Therefore, no problem arises in view of operation even if any of the backup routers fails.

However, according to the object of the present invention, it is necessary for all routers to monitor the operation status so that any backup routers can perform routing processing. When a fault occurs on any router, other router is required to perform routing processing in place of the failed router.

Accordingly, when applying the present invention, it is necessary to solve a problem of ‘being unable to detect a fault on backup routers’. For this purpose, an extended function described below is introduced in the present invention.

On receiving an advertisement packet, a backup router transmits a response with a format shown in FIG. 3 (with ‘Type’ set to ‘2’) to report the status of the backup router itself. The master router side, when receiving no response from the backup router for a certain period, determines that a fault occurred on the backup router concerned. The master router then registers the status of the backup router into distributed processing data table 32.

In addition, for implementing the present invention, an extended format of the VRRP advertisement packet shown in FIG. 3 is introduced for the transmission and reception of control packets between the routers. To transmit advertisement packets necessary for advertising to all routers at one time, multicasting is used as in the case of standard VRRP method. Also, as for a packet to be sent to an individual router, a destination address is specified using the registered IP address of each router (refer to FIG. 3) to transmit.

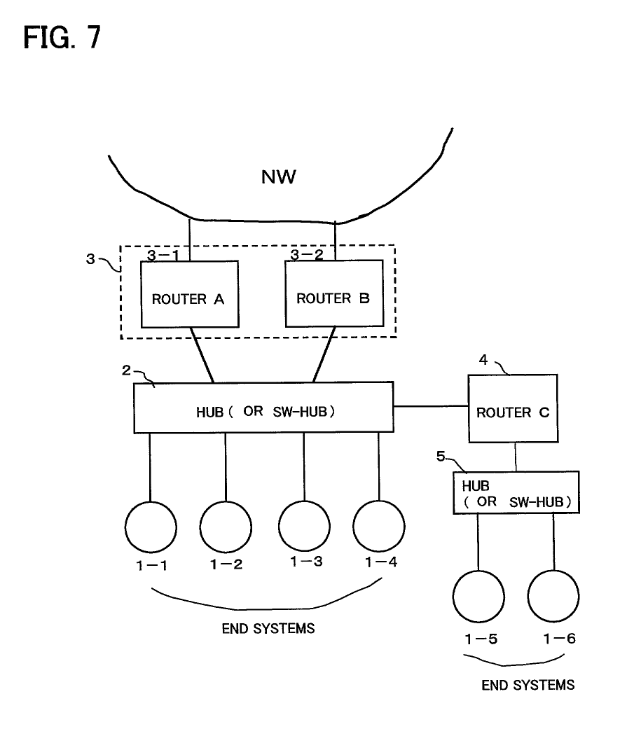

The operation of the present invention is described hereafter based on the above-mentioned configuration. In the following description, it assumed the network includes another subnet having end systems 1-5, 1-6 connected through a router 4 and a hub 5 as show in FIG. 7, in addition to the configuration shown in FIG. 1.

[Initial Operation]

In the network system shown in FIG. 7, either the master router or the backup router the plurality of routers 3-1, 3-2 constituting virtual router 3 starts operation according to the VRRP function.

In FIG. 7, router (A) 3-1 having the highest priority functions as the master router, while the other router (B) 3-2 functions as the backup router. Router 3-1 having been set as the master router transmits to backup router 3-2 the contents of distributed processing data table 32 by an advertisement message shown in FIG. 3, so that the data is shared between the master router and the backup router.

On receipt of the advertisement message from master router 3-1, backup router 3-2 returns a confirmation response by setting ‘Type’ to ‘2’ in the advertisement message. With this response, as mentioned earlier, master router 3-1 is able to determine that backup router 3-2 is maintained in normal operational condition.

Master router 3-1 further transmits an information request message to end systems 1-1 to 1-4, 1-5 and 1-6, so as to obtain subnet configuration information, i.e. information on end systems being existent in the subnet concerned. Here, ‘subnet’ denotes a sub network having the same domain name as that of a router.

ICMP (Internet Control Message Protocol) is applied for obtaining the above-mentioned subnet configuration information by the information request message. Information request/response message is specified in ICMP messages of the standard recommendation document RFC (Request for comments) 792, which is originally for use when the self network address in not known.

The format of ICMP message is shown in FIGS. 8A and 8B. Here, FIG. 8A shows a header part (IP header). ICMP information request/response message shown in FIG. 8B is added to the header part. ICMP information request/response message is identified using ‘Protocol’ in the header part shown in FIG. 8A. In the ICMP information request/response message format shown in FIG. 8B, ‘Type’ shows a request or response: ‘15’ denotes a request, while ‘16’ denotes a response. An identifier and a sequence number is used for coinciding the response with the request.

By means of an ICMP message, the information request is transmitted to all equipment inside the subnet using broadcast transmission, specifying ‘0’ in the network part of the source IP address. The reception side transmits a response after replacing the destination address with the received source IP address (FIG. 8A).

On reception of the information response message, master router 3-1 reads out the source address, to register the IP address of the end system constituting the subnet into distributed processing data base 32.

More specifically, first, when a router becomes the master router, master router 3-1 orders to transmit an ICMP information request message from a processor 331 (refer to FIG. 5) in virtual router controller 33 of the master router 3-1 concerned, to an ICMP message processor 37 which is a functional block provided for processing ordinary ICMP messages.

On receiving a response message to this request from each end system, a packet determination portion 35 in mater router 3-1 determines an ICMP message. (This can be determined from the protocol shown in FIG. 8A.)

Packet determination portion 35 then transfers the determined ICMP message to ICMP message processor 37.

When the message is determined to bean ICMP information response message from ‘Type’ in the format shown in FIG. 8B, processor 331 in virtual router controller 33 extracts the source IP address in the header (FIG. 8A) of the ICMP message to store into distributed processing data table 32.

Distributed processing data table 32 includes various kinds of information. These information is divided broadly into three categories.

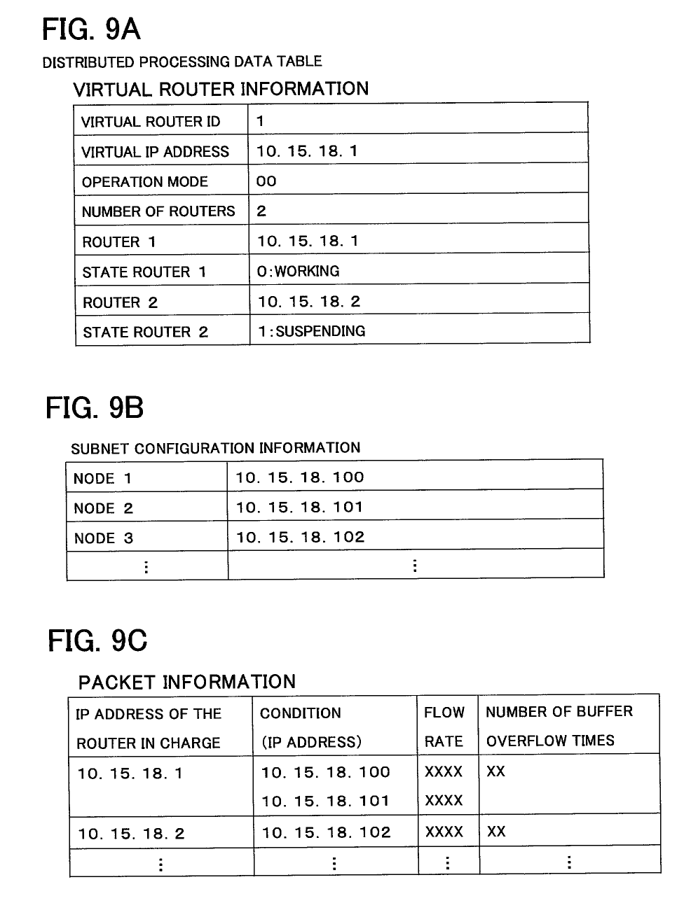

FIGS. 9A through 9C show examples of the information stored in distributed processing data table 32. Distributed processing data table 32 includes information tables of virtual router information (FIG. 9A), subnet configuration information (FIG. 9B), and packet information (FIG. 9C).

The IP address included in the above-mentioned response message corresponding to each end system is recorded in the subnet configuration information (FIG. 9B).

Here, as shown in FIG. 7, if the network system includes a router (C) 4 being connected to other subnet (which has end systems 1-5, 1-6 through hub 5) in addition to end systems 1-1 to 1-4, information on router 4 is also registered in subnet configuration information (FIG. 9B). In FIG. 9B, node#1, node#2, node#3, etc. are the routers located in each subnet.

In the above description, there has been shown a method for collecting information of end systems 1-1 to 1-4, and 1-5 to 1-6 using ICMP information request message. However it may also be possible to apply other methods. For example, first it is assumed that all addresses under the subnet address are allocated for each router as if these addresses exist. When a packet actually arrives at the router, the existence of the end system is determined and the information of the end system is registered as subnet information. The actual routing allocation is performed using the registered information.

After the configurations of the entire subnets are recorded into distributed processing data table 32 by the above-mentioned processing, it is allocated for each router to which packets the routing processing is to be performed. Confirmation messages are then transmitted from the router concerned.

Packets to be routed by each router is determined based on virtual router information (FIG. 9A) and subnet configuration information (FIG. 9B) recorded in distributed processing data table 32. The determined packets are then allocated for each router. In the following description, a router to which the routing function is allocated for each packet condition is referred to as a ‘router in charge’.

Processor 331 in virtual router controller 33 transmits to an allocation processor 334 an order to determine each router in charge conforming to each packet condition.

Here, the packet flow rate is not known in the initial state. When the packet allocation is performed in allocation processor 334 in the initial operation, available information is limited to the following: the number of routers constituting the virtual router; and the information of the subnet configuration. Considering the above situation, there has been derived a simple method such that the number of total end systems divided by the number of routers constituting the virtual router is allocated for each router.

Accordingly, the number of total end systems divided by the number of routers constituting the virtual router is allocated for each router. As an example, in FIG. 7, the number of routers constituting the virtual router is 2, and the total number of end systems is 6. Accordingly, three (3) end systems are allocated to each router 3-1, 3-2.

Allocation processor 334 refers to these sets of information through a data manager 332. At that time, the allocation is not performed to a router being in fault condition.

At the time the router in charge is determined, a message generator 333 in distributed processing virtual router controller 33 generates an allocation packet, to notify each router through transmission port 31. This advertisement is performed simultaneously using multicasting.

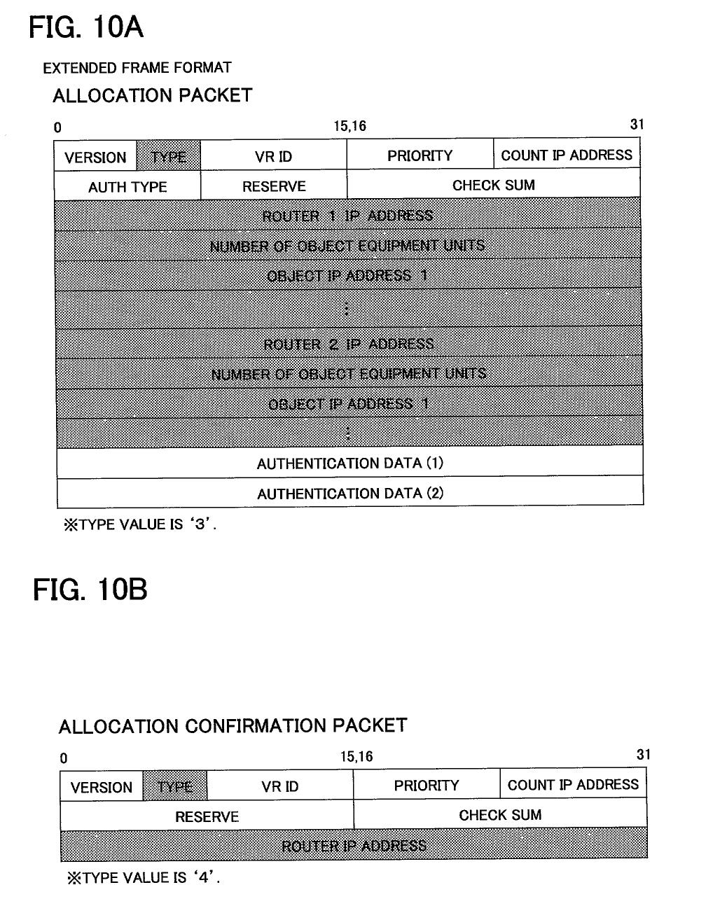

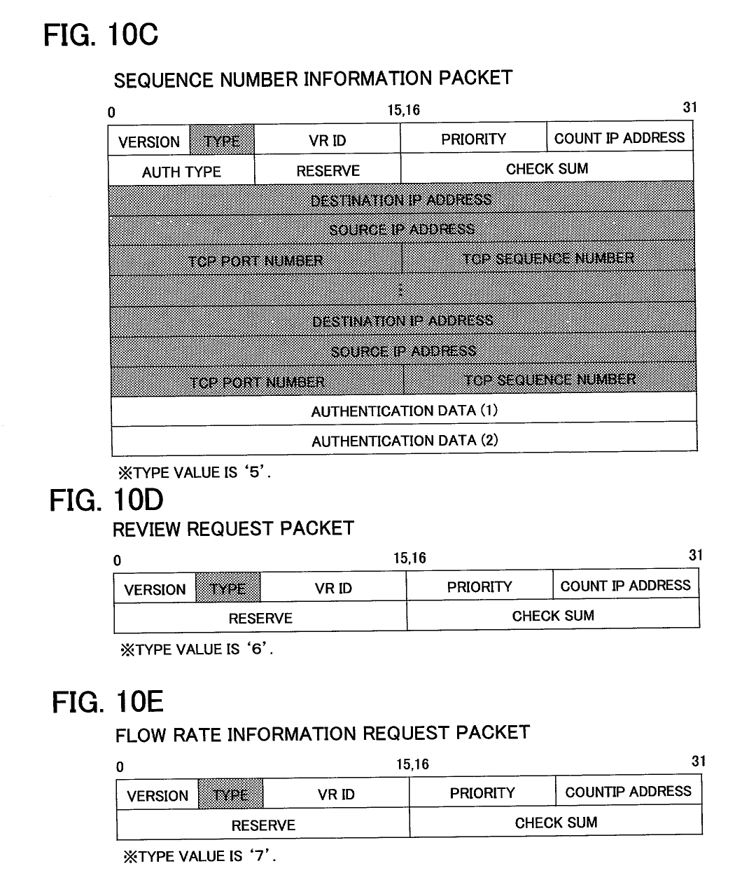

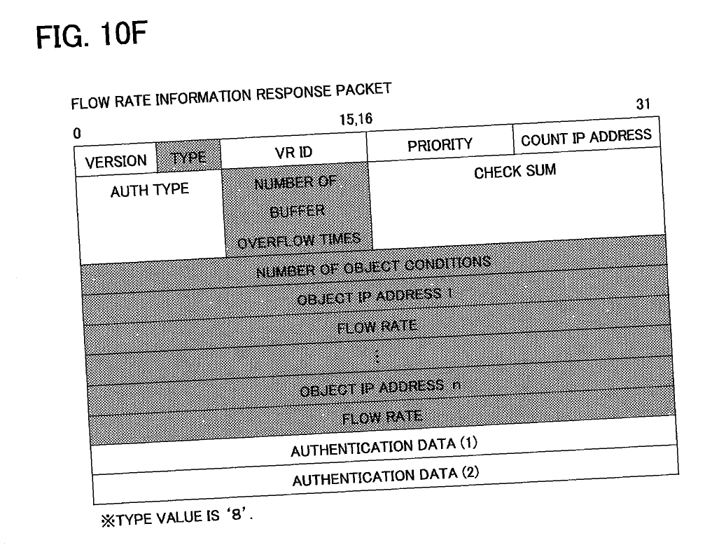

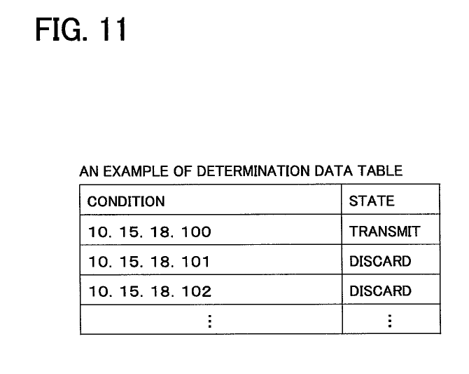

In FIGS. 10A through 10F, there are shown examples of an extended frame format of an advertisement frame format shown in FIG. 3, which is extended to apply to the present invention. In FIG. 10A, the format of the aforementioned allocation packet is shown. Now, the value of ‘Type’ is ‘3’.

FIG. 10B illustrates an allocation confirmation packet transmitted from a backup router. The value of ‘Type’ is ‘4’ now.

On receipt of the above allocation packet shown in FIG. 10A, the backup router becomes in working condition, to start routing processing of the packets which meet the notified condition.

The backup router having received the allocation packet determines whether or not the received packet is an allocation packet in a ‘Type’ value determination portion 330 (FIG. 5) of distributed processing virtual router controller 33 (FIG. 4).

Processor 331 in distributed processing virtual router controller 33 then performs a processing for routing the packet. For this purpose, processor 331 writes the allocation information into the packet information (FIG. 9C) in distributed processing data table 32 through data manager 332. At the same time, processor 331 writes the packet information into a determination data table 40 (refer to FIG. 4).

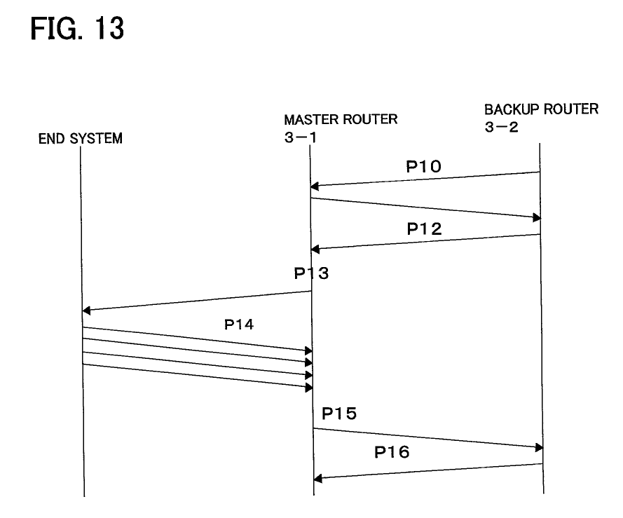

In determination data table 40, there are described a routing allocation condition for routing and how a packet conforming to the condition shall be handled. More specifically, as an example of determination data table 40 shown in FIG. 13, it is specified whether a packet conforming to each condition shall be transmitted (routed) or discarded.

Controller 331 also orders message generator 333 in virtual router controller 33 to generate an allocation confirmation packet (FIG. 10B) and transmits the allocation confirmation packet back to master router 3-1.

On receipt of the allocation confirmation packet, master router 3-1 performs the processing for removing from routing object thereof packets which conform to the aforementioned routing allocation condition (hereafter referred to as ‘conforming packet’), as well as the processing for discarding such conforming packets. At the same time, master router 3-1 modifies the corresponding router condition being recorded in distributed processing data table 32 from ‘suspended’ to ‘working’.

When ‘Type’ value determination portion 330 determines that the received packet is an allocation packet, processor 331 orders data manager 332 to modify the router condition in distributed processing data table 32 from the ‘suspended’ state to the ‘working’ state.

Also, processor 331 orders to modify the router condition in determination data table 40 of master router 3-1 so as to inhibit routing of the corresponding packet.

[Prevention of Packet Duplication]

As mentioned earlier, each router starts routing processing by receiving an allocation packet from mater router 3-1. It is to be noted that there may possibly occur packet duplication (caused by simultaneous routing by the master router and the backup router) until the conforming packet is removed from the routing object specified in determination data table 40 in master router 3-1.

To cope with this problem, according to the present invention, two measures are introduced. Which of the two measures being actually selected in the system is recorded as an operation mode (FIG. 9A) in the virtual router information. This record is set manually into each router. The operation being actually performed is based on the mode having been specified by master router 3-1. In other words, when the master router is switched over to router 3-2 due to a fault, the operation is performed based on the operation mode set in the new master router 3-2.

[Preventing Packet Duplication by Means of Timer]

Each backup router 3-2, when receiving an allocation packet (FIG. 10A) from master router 3-1, generates a certain delay before the start of routing processing. During this period, master router 3-1 receives an allocation confirmation packet (FIG. 10B).

On receiving the allocation confirmation packet, the master router 3-1 removes the conforming packet from the routing object, thus preventing packet duplication. More detailed processing is described below:

When each backup router 3-2 receives an allocation packet (FIG. 10A) from master router 3-1, processor 331 in virtual router controller 33 orders data manager 332 to record the allocated information into distributed processing data table 32.

At the same time, processor 331 orders message generator 333 to transmit an allocation confirmation packet to master router 3-1. Also processor 331 orders timer 34 to generate a certain delay, enabling to protect determination data table 40 from writing information on the conforming packet.

When the elapse of the delayed timing is reported by timer 34, processor 331 writes the packet information conforming to the routing condition into determination data table 40 so that any conforming packet is processed as an object of routing processing.

The above-mentioned method is more advantageous than the method shown below, because the processing is simpler. However there is a problem that packet loss may occur.

[Preventing Packet Duplication by Means of Sequence Number]

As mentioned above, packet losses may occur by the above-mentioned method using a timer, while packet duplication is avoidable. To cope with this problem, the following method is applicable for preventing both packet duplication and packet loss: On receiving the allocation confirmation packet, master router 3-1 removes the conforming packet from the object of routing. At that time, master router 3-1 examines to which packet the routing processing has been completed.

Master router 3-1 then reports to the corresponding backup router 3-2 the TCP sequence number of the conforming packet having been buffered into a buffer processor 38 (refer to FIG. 4). This TCP sequence number information is transmitted using a sequence number information packet shown in FIG. 10C.

When processor 331 in master router 3-1 confirms the reception of the allocation confirmation packet (FIG. 10B), processor 331 checks the current packet state against the condition allocated to backup router 3-2 having transmitted the related allocation confirmation packet.

More specifically, processor 331 orders a packet conformity identification portion 394 (FIG. 6) in a packet monitor 39 to return information on the conforming packet having been stored in the buffer.

Packet conformity identification portion 394 extracts the oldest packet among the conforming packets having been stored in buffer processor 38 on each condition by condition basis, to forward to buffer checker 392.

Packet conformity identification portion 394 checks whether the packet is transmitted from any one of IP addresses allocated to backup router 3-2. This check is performed in order of reception beginning with the oldest packet. If the packet is the conforming packet transmitted through TCP (transmission control protocol: a transport layer protocol for transmitting connection packets), then the source IP address, destination IP address, port number and sequence number in the packet is checked and reported to processor 331.

Also, the packet conforming to the above condition is discarded at that time. The succeeding packets having the identical condition stored in the buffer are merely discarded without notifying the information.

Meanwhile, if the packet is the conforming packet received from the corresponding IP address and is transmitted through UDP (user datagram protocol: a transport layer protocol for transmitting connectionless packets, in which only data transmission is carried out), then the packet is discarded unconditionally.

Also, if no TCP packet is found among the packets received from the corresponding IP address during the processing in buffer processor 38, a report is sent to processor 331 indicating ‘conforming packet not found’.

Processor 331, after receiving the sets of information on a per condition basis, notifies message generator 333 of these sets of information, and generates a sequence number information packet, and orders to transmit the sequence number information packet to the corresponding backup router 3-2.

On receipt of the sequence number information packet (FIG. 10C), backup router 3-2 discards the packets conforming to the identical condition and having an older TCP sequence number than the transmitted sequence number among the packets having been stored in buffer processor 38. Backup router 3-2 then starts routing processing against the packets having newer sequence number than the transmitted sequence number.

In the above-mentioned manner, both packet duplication and packet loss can be prevented.

More specifically, on receipt of the sequence number information packet, processor 331 in backup router 3-2 orders packet conformity identification portion 394 in packet monitor 39 to discard the conforming packets having older sequence numbers than the received sequence number.

Packet conformity identification portion 394 then requests buffer checker 392 to find out packets which agree with the sequence number information of the conforming packet on each condition by condition basis. Buffer checker 392 checks whether there is any conforming packet from the top of the buffer.

In this check, any packet which meets the condition but does not agree with the packet conformity information is discarded. When a packet which meets the conformity is detected, the check processing is terminated on that condition.

According to this method, UDP packets may possibly be discarded. However, this is neglected here because the loss of a UDP packet is not a serious problem if the number of deleted packets are small.

Here, there may be a case that although a conforming packet (conforming to the allocation condition) has been stored in the buffer of backup router 3-2, ‘conforming packet not found’ information in respect of sequence number, etc. is indicated from master router 3-1 using the sequence number information packet. In such a case, the determination depends on which position the packet of interest is stored in the buffer of backup router 3-2. If the packet is positioned in the latter portion of the buffer, the conforming packet is left there for further processing. If the packet is located on the former portion of the buffer, the packet is deleted.

In this method, when the allocation packet is received, the object packet information is stored in determination data table 40. An order is sent to a transfer function portion 36 not to forward the packets having been stored in the buffer until buffer processor 38 receives a permission. This order is released by processor 331 when a sequence number information packet is received.

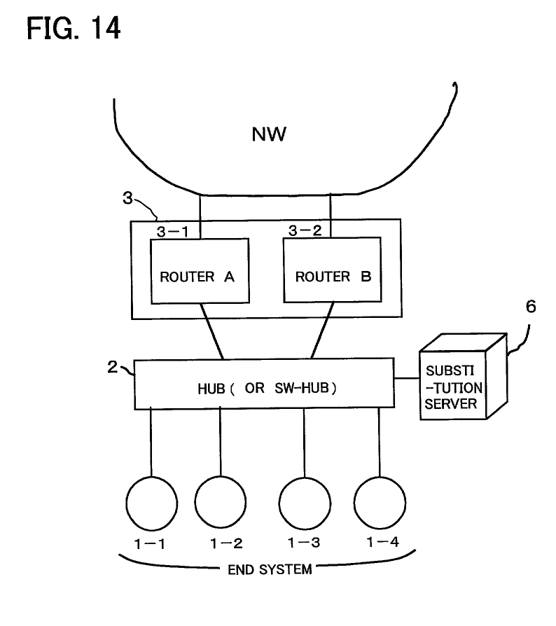

The above-mentioned operation is summarized in the flowchart shown in FIG. 14.

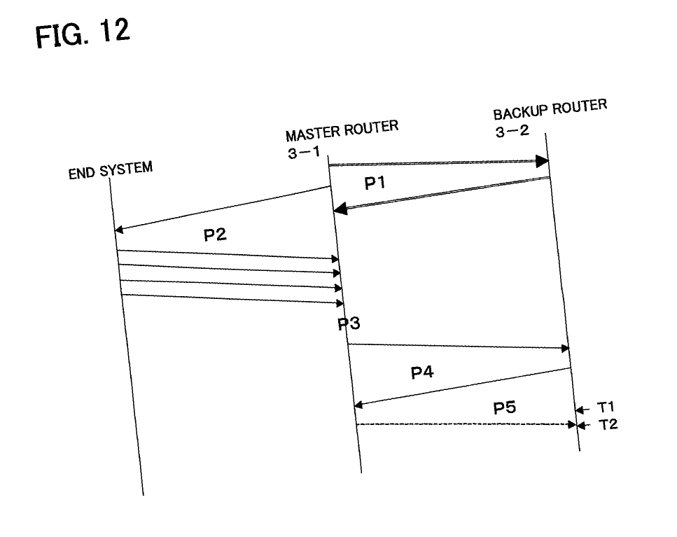

In FIG. 12, there is shown a packet flow between master router 3-1, backup router 3-2, and end systems 1-1 to 1-4 and 1-5 to 1-6 in the initial operation including the packet duplication prevention.

Each advertisement packet shown with a bold line (procedure P1) is transmitted and received between master router 3-1 and backup router 3-2. This is carried out periodically like a standard VRRP advertisement packet.

In procedure P2, packets for collecting information are transmitted from master router 3-1 to respective end systems 1-1 to 1-4 and 1-5 to 1-6. The response to these packets are also included in this procedure.

When information is collected from respective end systems 1-1 to 1-4 and 1-5 to 1-6, master router 3-1 performs an allocation processing (procedure P3).

On completion of the allocation processing (procedure P3), the result thereof is notified to backup router 3-2. Backup router 3-2 having received this advertisement then transmits a response to this advertisement (procedure P4).

Next, master router 3-1 performs above-mentioned packet duplication prevention processing by notifying backup router 3-2 of sequence number (procedure P5). The sequence number advertisement is performed using a sequence number information packet shown in FIG. 10C. When this packet duplication prevention is performed using sequence number advertisement, routing processing is started at timing T2. When another packet duplication prevention method using timer processing is applied, the routing processing is started at timing T1.

[Allocation Reviewing and Reallocation]

As a result of the routing allocation, distributed processing is carried out. However deviation may possibly be produced depending on the varied number of packets. To cope with this problem, a review is taken place when necessary.

The review is carried out triggered by either master router 3-1 or backup router 3-2. The difference of the above two method is the method of information collection for determining the necessity of the review: In the former method, the information collection is carried out by master router 3-1 voluntarily, while in the latter method the information collection is carried out by master router 3-1 requested by backup router 3-2 to master router 3-1.

Once the information is collected for determining the necessity of the review, the determination processing as well as the reallocation processing is carried out by the same processing, irrespective of the above two methods.

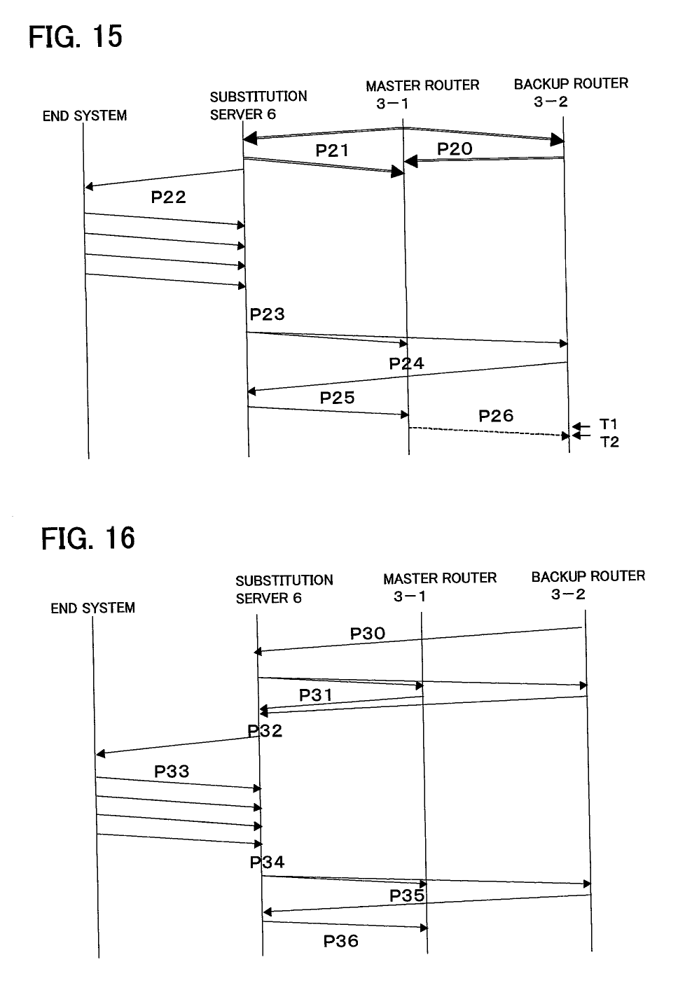

As an embodiment, the processing in the case the request is originated by backup router 3-2 is described hereafter. Referring to the sequence diagram shown in FIG. 15, how the processing is performed in each function block is explained.

Regularly, packets to be routed are monitored both by master router 3-1 and backup router 3-2. Packet monitoring is performed in packet monitor 39 to monitor two sets of information:

One is the number of times of buffer overflow, and the other is the flow rate of the packets conforming to each condition. Here the packet flow rate is represented by bps (bit per second) considering the lengths of the packets.

The buffer overflow monitoring is carried out in a buffer overflow monitor 390 (refer to FIG. 6). Buffer overflow monitor 390 notifies buffer overflow counter 391 of the event of buffer overflow in buffer processor 38.

Buffer overflow counter 391 counts the number of overflows having occurred during a time unit. The count information is notified to a condition determination portion 395 and a flow rate record controller 396.

Further, the packet flow rate conforming to each condition is monitored by buffer checker 392. Buffer checker 392 also has a function to check the information of the packet passing through buffer processor 38. Each packet information is checked at a short interval, to collect on a per condition basis in a flow rate checker 393 to forward to a flow rate record controller 396.

Flow rate record controller 396 periodically writes into distributed processing data table 32 the number of times of buffer overflow occurred during a time unit at present, as well as data of an average packet flow rate on a per condition basis (unit: bps) which was measured before for a certain time period.

Meanwhile, the number of times of buffer overflow and the average packet flow rate on a per condition basis which were forwarded to a condition determination portion 395 are used for determining whether or not the review is required in condition determination portion 395.

In condition determination portion 395, threshold values for defining the comparison condition is set manually. The set threshold values for the comparison are compared to the set of information of the packet flow rate and the number of times of the buffer overflow.

When the above set of information is determined larger than the threshold values, condition determination portion 395 determines it is necessary to review the routing allocation. A request is transmitted to a review processor 335 in virtual router controller 33 requesting the confirmation for the review.

In the case of backup router 3-2, on receipt of the confirmation request for reviewing, review processor 335 orders message generator 333 to generate a review request packet (FIG. 10D) for transmitting to master router 3-1.

On receipt of the review request packet from backup router 3-2, master router 3-1 determines the review request packet (having type value of ‘6’) in ‘Type’ value determination portion 330, to inform review processor 335 of this result.

In response to the review request from backup router 3-2, review processor 335 orders backup router 3-2 to transmit a flow rate information request packet (FIG. 10E) so as to collect information on whether or not reallocation is actually necessary.

When backup router 3-2 determines the reception of flow rate information request packet (having type value of ‘7’) in ‘Type’ value determination portion 330, backup router 3-2 transmits a flow rate information packet to review processor 335. Review processor 335 then extracts information on the flow rate stored in distributed processing data table 32 through data manager 332.

Further, review processor 335 orders message generator 333 to generate a flow rate information response packet (having type value of ‘8’: refer to FIG. 10F) to transmit the response to master router 3-1.

On receipt of the flow rate information response packet, master router informs review processor 335, and then writes the data into distributed processing data table 32 managed by data manager 332. Using such procedure, information necessary for determination is collected.

In addition to the aforementioned triggering from backup router 3-2, the determination of whether or not the review is necessary is carried out also when there are a large quantity of packet flow being transmitted from master router 3-1 itself. In this case, review processor 335 orders message generator 333 to prepare a flow rate information request packet (FIG. 10E) to transmit backup router 3-2.

The rest of the procedure after this information collection is identical to the case when the process is triggered by the request from backup router 3-2. Finally, when the flow rate response packet (FIG. 10F) is received from backup router 3-2, the received information is stored into distributed processing data table 32.

Master router 3-1 confirms the necessity of review processing either when master router 3-1 determined the review is necessary as a result of packet flow rate monitoring, or when backup router 3-2 determined the review is necessary as a result of packet flow rate monitoring requesting mater router 3-1 to perform the review processing.

In the sequence diagram shown in FIG. 15, backup router 3-2 requests mater router 3-1 to perform the review processing because backup router 3-2 determines the review is necessary (procedure P10). On receipt of the request, master router 3-1 orders backup router 3-2 to notify the information on the flow rate, and then backup router 3-2 notifies the information in response to the request (procedure P12).

After the information required for the determination is collected, master router 3-1 determines whether or not the review is necessary (procedure P13). This determination criterion is set manually in review processor 335, which includes the case that the difference between the amount of average packet flow rate allocated to each router exceeds the manual preset value, and that the difference between the number of buffer overflow per time unit exceeds the manual preset value.

When either of the above-mentioned criterion is satisfied, master router 3-1 orders allocation processor 334 to start the reallocation processing.

Allocation processing is performed in a manner similar to the processing in the initial condition. That is, the configuration of end systems 1-1 to 1-4 and 1-5 to 1-6 is reviewed and the allocation is performed using an allocation algorithm. An example of the allocation method is to place each condition in order of the flow rate, and then to allocate to each router substantially equal amount out of the total flow rate.

Here, in case there is a newly added end system, the current flow rate of the system is assumed as zero. When the allocation is determined, backup router 3-2 is informed of this allocation result as in the case of the initial operation.

In the flow shown in the sequence chart of FIG. 13, at the timing of P13, mater router 3-1 determines whether or not the review is necessary. The reallocation processing is carried out when it is determined necessary.

In FIG. 13, the processing of the procedures P14 to P16 has the same procedures as those in the case of the ordinary initial operation (procedures P2 to P4 in FIG. 12).

Here, if this review processing is performed at a frequent period, large processing load may be imposed on each router for collecting information for determination. Therefore, each processing is controlled so as not to be performed for a certain period after the review request packet is transmitted to master router 3-1 (in the case of backup router 3-2), or after the flow rate information request packet (FIG. 10E) is voluntarily transmitted (in the case of master router 3-1).

For this purpose, when each review processor 335 orders message generator 333 to generate a flow rate information request packet, review processor 335 orders timer 34 to stop a timer provided for the suspension of the review operation for a certain period. According to the above processing, review processor 335 suspends to perform the corresponding review operation until a timer release information is received from timer 34. Thus review processor 335 suspends processing for a certain period irrespective of executing or not executing the reallocation in the allocation processing.

[Management by Separate Equipment]

In the aforementioned operation, processing load may be increased in each router for the processing other than the routing processing, which may possibly causes an undesirable case.

In order to cope with this problem, according to the present invention, it is also possible to provide another server which substitutes for master router 3-1 so as to perform the processing by master router 3-1 in the aforementioned method.

In FIG. 14, there is shown a system configuration, in which a substitution server 6 is provided for substituting to perform the related processing by master server 3-1. This server 6 is required to provide a function related to virtual router 3 for distributed processing, as well as a function related to ICMP (Internet Control Message Protocol), which is treated as a special router constituting virtual router 3.

An operation flowchart performed by substitution server 6 being provided for substituting for the processing by master router 3-1 is described referring to FIG. 15.

Substitution server 6 is required to register in advance as one of the routers constituting virtual router 3. Substitution server 6 is registered using an identification number which indicates a router condition as a server for substitution.

Master router 3-1 transmits an advertisement packet as in the case of the ordinary VRRP. Also, responses to the advertisement packet are transmitted from both substitution server 6 and backup router 3-2 in the same manner as that in the ordinary case. Packets are transmitted and received periodically as shown in bold lines (procedure P20, P21) as ordinary VRRP advertisement packets in the previous method, so as to confirm normal operations of each other.

On receipt of an advertisement packet from master router 3-1 to confirm the operation of virtual router 3, substitution server 6 transmits a packet to end systems 1-1 to 1-4 and 1-5 to 1-6 for requesting information (procedure P22). Each end system responds to substitution server 6. Such processing is identical to the processing performed by only routers 3-1 and 3-2 shown in FIG. 12.

At the time when information is collected from each end system, substitution server 6 starts the allocation. The allocation processing is carried out in a similar manner to that of master router 3-1 (procedure P23).

When the allocation is determined, substitution server 6 informs master router 3-1 and backup router 3-2 of the result of the allocation (procedure P24). At this time, router 3-1, which identifies itself as a master router, records the information into distributed processing data table 32 without transmitting a response. The response is transmitted only from backup router 3-2.

On receipt of the response message from backup router 3-2, substitution router 6 transfers the response message to master router 3-1 (procedure P25). For this reason, a preset timer value of the timer 34 is required to have a substantially large number, in the case the method using timer 34 is applied to avoid packet duplication. In FIG. 15, the routing process by backup router 3-2 is started at the timing of T2.

When the method using the sequence number is applied for avoidance of packet duplication, a packet transmission shown with a dotted line is made (procedure P26). This is carried out directly from master router 3-1, which is identical to the case substitution server 6 is not introduced.

Next, referring to FIG. 16, there is illustrated an operation procedure of the review processing using substitution server 6 in the configuration shown in FIG. 14. A review request is transmitted from either master router 3-1 or backup router 3-2 to substitution server 6 (procedure P30).

On receipt of the review request, substitution server 6 requests the information from master router 3-1 and backup router 3-2. Master router 3-1 and backup router 3-2 then respond to substitution router 6 with the information on both a packet flow rate and the number of buffer overflows during a certain period (procedure P31).

Substitution server 6 determines whether or not the review is necessary using these sets of information. The determination criterion and the determination processing of the necessity of review are the same as the case of review processing performed by master router 3-1 (procedure P32).

When the review is determined necessary, substitution server 6 collects information from end systems 1-1 to 1-4 and 1-5 to 1-6, in a similar manner to the initial operation shown in FIG. 15 (procedure P33). After that substitution server 6 performs the reallocation processing (procedure P32), to inform both master router 3-1 and backup router 3-2 of the result of reallocation (procedure P33).

Additionally, when a failure occurs in substitution server 6, making unable to perform such processing as mentioned above, the condition of substitution server 6 (substitution server: fault) is set into master router 3-1 and master router 3-1 performs the processing without using substitution server 6.

[Services Using the Method of the Present Invention]

Using the method of the present invention, it may be possible to connect a plurality of corporate firms through either a carrier network providing IP virtual private network service or an ISP (Internet Service Provider) network.

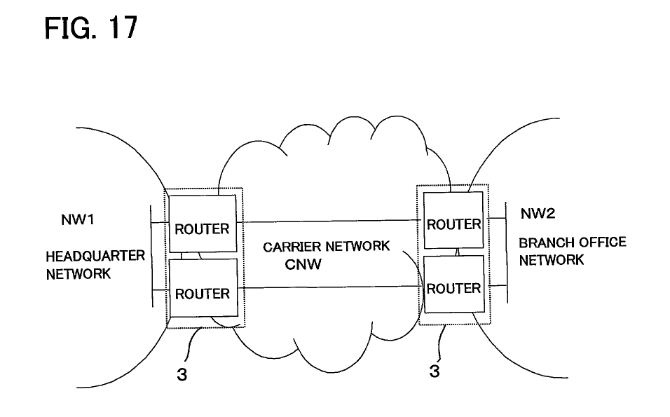

In FIG. 17, there is shown a configuration example in case of a simple connection between two points for the sake of explanation. In FIG. 17, a headquarter network NW1 and a branch office network NW2 are connected through a carrier network CNW.

Virtual router 3 is provided between headquarter network NW1 and carrier network CNW, as well as between branch office network NW2 and carrier network CNW. The present invention of which embodiments have been described above can be applied to this virtual router 3.

Having been explained referring to the drawings, the dynamic load sharing system according to the present invention has the following advantages: Simply, the packet processing capability is increased in comparison with the conventional system incorporating a virtual router with a redundant configuration because a plurality of routers 3-1, 3-2 are concurrently operated. Also, compared with a static load sharing system with a redundant configuration, a time-consuming task of statically sharing the load based on the estimated packet amount transmitted from each terminal is not necessary. Further, the system according to the present invention can cope with a load variation flexibly.

Inevitably the redundant configuration produces an advantage of high reliability against failure.

Such advantages of the present invention enable to provide a system which realizes good response, high reliability and load sharing capability.

Moreover, compared with the conventional system having a virtual router with a redundant configuration, the system according to the present invention having the above-mentioned advantages achieves effective utilization of the bandwidths in both equipment and transmission paths because a plurality of routers can be operated concurrently. Also, the effective load sharing can be attained because of the flexible functionality against the load deviation, as compared with the conventional static load sharing method with the provision of a plurality of default gateways.

According to the present invention, each end system can be provided with an identical setting of a default gateway. Therefore, it is not necessary to consider in advance a packet flow rate of each end system in detail which is required in setting load sharing statically. Accordingly the network setting including the network designing becomes quite easier.

Because of the aforementioned advantages of the present invention, in a network operated by either a carrier or an ISP providing an IP-VPN service, services having good response, high reliability and load sharing function are realized by incorporating the router having the function of the present invention into the network.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A dynamic load sharing system using a virtual router comprising:
a plurality of equipment units each functioning as a router which constitutes said virtual router having a single common address; and
an end system connected to a network through said virtual router,
wherein one of said equipment unit among a plurality of equipment units functioning as a router constituting said virtual router is assigned as a master router, while each of the other equipment units functioning as a router is assigned as a backup router, and said assigned master router dynamically sets a packet condition for defining the routing object to transmit to said backup router, so that routing processing between said network and said end system is performed by said plurality of equipment units each functioning as a router.

2. The dynamic load sharing system using the virtual router according to claim 1,
wherein when said backup router receives from said master router the information of packet condition for defining the routing object, said backup router transmits a response message to said master router.

3. The dynamic load sharing system using the virtual router according to claim 1,
wherein after said master router notifies said backup router of said packet condition for defining the routing object, said master router removes said packet condition being allocated to said backup router from the packet condition for defining the routing object of said master router itself.

4. The dynamic load sharing system using the virtual router according to claim 2,
wherein after said backup router transmits said response message to said master router, said backup router is set to suspend routing processing for a predetermined period.

5. The dynamic load sharing system using the virtual router according to claim 2
wherein on reception of a response message packet from said backup router, said master router removes the allocated packet condition for defining the routing object, and notifies said backup router of a sequence number of the packet the routing processing for which is completed by said master router.

6. The dynamic load sharing system using the virtual router according to claim 5,
wherein said backup router discards a packet having been routed by said master router from among buffered packets based on said sequence number information transmitted from master router, and performs routing processing from the succeeding packet to said discarded packet.

7. The dynamic load sharing system using the virtual router according to claim 1,
wherein said backup router includes a monitor means for monitoring flow rate information of the packets being routed by said backup router itself.

8. The dynamic load sharing system using the virtual router according to claim 7,
wherein when said packet flow rate monitored by said monitor means exceeds a predetermined value, said backup router requests said master router to review said packet condition for defining the routing object.

9. The dynamic load sharing system using the virtual router according to claim 7,
wherein said master router collects said flow rate information monitored by said monitor means in said backup router, to review packet condition for defining the routing object when said packet flow rate exceeds a predetermined value.

10. The dynamic load sharing system using the virtual router according to claim 9,
wherein said flow rate information collection from said backup router being performed by said master router is initiated by a request from said backup router.

11. The dynamic load sharing system using the virtual router according to claim 9,
wherein the reallocation of routers for routing packets is initiated by said packet condition review.

12. The dynamic load sharing system using the virtual router according to claim 11,
wherein said review request from backup router is inhibited for a predetermined period irrespective of said router reallocation for routing packets.

13. The dynamic load sharing system using the virtual router according to claim 11,
wherein said master router suspends said information collection for a predetermined period irrespective of said router reallocation for routing packets.

14. The dynamic load sharing system using the virtual router according to either claim 1 to claim 13,
wherein said dynamic load sharing system further comprises a server performing the functions of modifying packet information for routing and obtaining configuration information of said end systems.

15. The dynamic load sharing system using the virtual router according to claim 1,
wherein said network includes a carrier network providing an IP virtual private network service (IP-VPN service) or an ISP (Internet service provider) network.
